(19) United States
(12) Patent Application Publication
(10) Pub. No.: US 2006/0139456 A1
(43) Pub. Date: Jun. 29, 2006

(54) Device for and a method measuring sizes on photomasks

(76) Inventor: Arkady Nikitin, Yonkers, NY (US)

Correspondence Address: Ilya Zborovsky, 6 Schoolhouse Way, Dix Hills, NY, 11746, US

(21) Appl. No.: 11/011,218

(22) Filed: Dec. 14, 2004

(51) Int. Cl. H04N 5/225; H04N 9/04

(52) U.S. Cl. 348/207.99

(57) ABSTRACT

A device for measuring sizes on photomasks has a television optical microscope, a system of periodical changing a resolution of the microscope, a regulated source of a base voltage, a comparator of a base signal and a television signal, and a former of short pulses, and a display unit.

### BACKGROUND OF THE INVENTION

The present invention relates to a device for and a method of and a method of measuring sizes on photomasks.

A problem of measurements of sizes on photomasks is quite acute in the present, as can be confirmed for example by continuous flow of publications related on this subject, such as for example Journal of Microlithorgraphy, Microfabrication and Microsystem, volume 3, no. 2, April 2004, pages 203-231; M. Bom, E. Wolf, Principles of Optics. Pergamon Press. Oxford, 1970; Nikitin, A. V.; Nikitin, M. A.; Suris, R. A., Forming of the Images by Optical System in the Projective Photolithrography. Electron Industry, 1980, issue 5, pages 27-32.

Certain successes in measurements of sizes of elements of integral circuits on silicon wafers connected with improvements in methods of measurements with scanning electron microscope can not be directly transmitted to the measurements of elements on photomasks. The main reason for this is a problem of electrical charge, which is generated during irradiation of glass (quartz) mask with a beam of electrons. There are many proposals related to a reduction of effects of charging of dielectric objects in scanning elecron microscope in specific cases; however, no universal approaches, which completely eliminate the influence of this effect have been proposed.

### SUMMARY OF THE INVENTION

Accordingly, it is an object of the present invention to provide device for measuring sizes on photomasks in which a very special method of optical measurements of sizes is proposed, free of generation of a charge of an object to be controlled.

In keeping with these objects and with others which will become apparent hereinafter, one feature of the present invention resides, briefly stated, in a device for measuring sizes on photomasks, comprising a television optical microscope; a system of periodical changing a resolution of the microscope; a regulated source of a base voltage; a comparator of a base signal and a television signal; a former of short pulses; and a display unit.

It is a further object of the present invention to provide a method of measuring sizes of photomasks, comprising the steps of providing a television optical microscope; periodically changing a resolution of the microscope; regulating a source of a base voltage; comparing a base signal and a television signal; forming short pulses; and displaying on a display unit.

When the device is designed in accordance with the present invention, it eliminates the disadvantages of the prior art.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view schematically showing a device for a linewidth measurement on masks;

FIG. 2 is a view illustrating a principle of operation of the inventive device; and

FIGS. 3 and 4 are views showing corresponding images.

### DESCRIPTION OF THE PREFERRED EMBODIMENTS

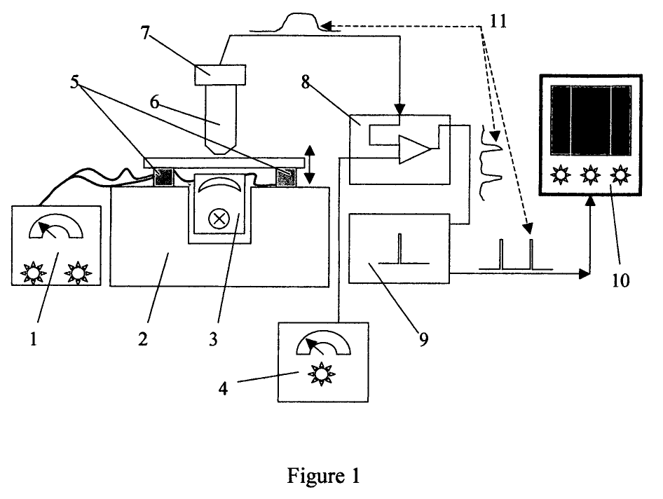

A device for measuring sizes on photomasks (masks) includes a measuring optical microscope of a television type identified with reference numerals 6 and 7 in FIG. 1, wherein 6 is a microscope and 7 is a television video camera. It further has a table for positioning a template 11 to be measured and identified with reference numeral 2, a light source 3, systems for periodical change of a resolution of the microscope identified with reference numerals 1 and 5, wherein 1 is an oscillation circuit and 5 are piezoelectric elements, a regulated source of a base voltage 4, a comparator of signals 8, a former of short pulses 9, and a displaying unit 10.

FIG. 1 shows the device in which for periodical change of a resolution of the microscope, a partial defocusing of an image due to displacement of the photomask along an optical axis of the microscope is utilized. For this purpose the device includes a generator of disturbing signals, and a mover of piezo-electric, magneto-strictive or another type which is controlled by the generator and on which the photomask to be measured is mounted. In accordance with another variant, for this purpose the device has a generator of disturbing signals and a mover of a piezoelectric, magneto-strictive or another type which is controlled by the generator and performs displacement of an objective.

The device designed in accordance with the first variant operates in the first manner.

The photo template 11 is placed on a table 2, and a vibrating movement is imparted to it by the vibrator 5 along an optical axis with frequency Ω and an amplitude A. The frequency Ω is not critical for the operation of the device. It must be only greater than a frequency of a frame scanning of the television image, but less than a frequency of the line scanning. The amplitude A must be selected many times greater than a “depth of focus” of the microscope. For the microscope a light source with a wave length λ=0.248 micron, the “depth of focus” T is calculated in accordance with a known formula

$$T = \frac{0.61 * λ}{2 * {( NA )}^{2}} = 0.21 mcm$$

For reliable operation of the measuring device it suffices to select the amplitude of oscillations of mask 2-3 times greater than T. Thereby, for the measuring device of this type the amplitude which is sufficient is A=0.5-0.7 mcm.

As will be explained herein below, the shape of oscillations of the mask is also unimportant: it can be sine-shaped, triangular, or another one.

The system of processing of the television signal operates in the following manner. Each line of the image is supplied to an input of the signal comparator 8. The comparator is an electronic device with two inputs and one output. At the output of the comparator a signal is generated only when signals of equal magnitude are supplied to its two inputs. In different conditions, a signal at its output equals zero. In the described device, a line of image with a value of signal changing in time 11 is supplied to one input, and a signal with a constant value from the regulated source of base voltage 4 is supplied to the second input. At the output of the comparator a non-zero signal appears in the moment, when the value of signal from the line of image becomes equal to the base signal from the source 4. The output signal of the comparator 8 triggers the former of pulses 9 (signal vibrator, monostable multi vibrator), which forms a single powerful short pulse. This pulse lightens a bright point on the line of scanning of the observation device or display 10. Since the system of scanning on the screen is exactly synchronized with the scanning of the transmitting television camera 7, the position of the lighting point on the screen approximately corresponds to the position of the “edge” of the line to be measured in its television image.

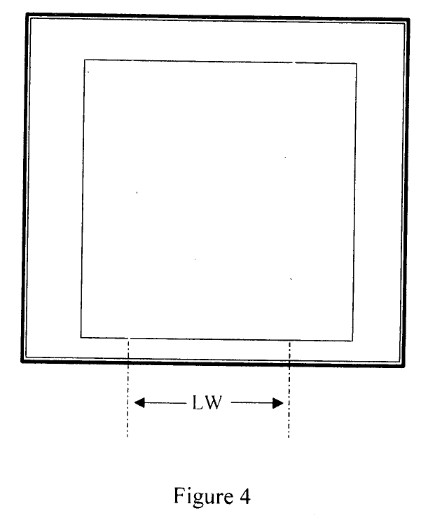

If the vibrator 5 is turned off, all lines of the image are identical. The comparator is triggered in the same moments of time on all lines. As a result, on the screen a straight line will be observed which corresponds to a conditional edge of the strip to be measured, as shown in FIG. 4. It is advisable to explain why the position of the edge determined in this manner is conditional. It is true that when the value of the base signal from the source 4 in FIG. 1 is changed, the position of this line on the screen changes. Therefore the problem of pointed localization of the edge requires some additional aspects, which are provided by the present invention.

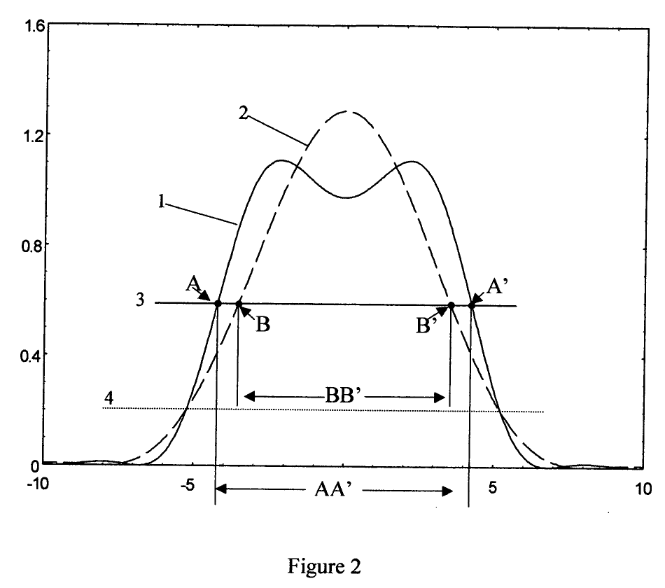

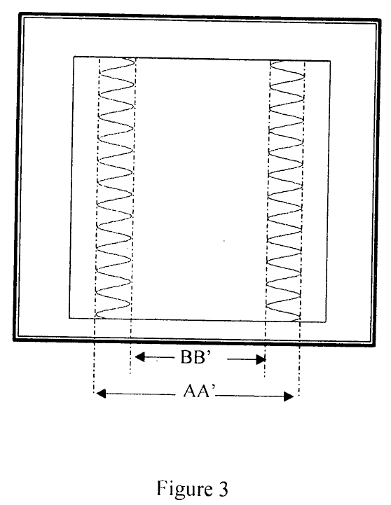

The behavior of the system when the vibrator is turned on is as follows. Turning now to FIG. 2, it can be seen that the curve 1′ on this Figure corresponds to the line of the sharply focused image of the transparent strip on a dark field. The comparator together with the former of pulses lightens on the screen the points A and A′, with a distance therebetween A, A′ which can be considered to be a conditional size of the strip. A next line which is read during another interval of time, due to the operation of the vibrator 5 on FIG. 1, will be partially defocused, as shown in curve 2′. The position of the edges on this line changes (points B and B′), and a distance therebetween or in other words the size of the strip will be equal B, B′. Therefore, as a result of a period defocusing, the conditional size of the strip will change from one line to another, repeating variations of defocusing in accordance with frequency, amplitude and shape of oscillations of the photomask. On the screen an image similar to FIG. 3 will be seen.

It should be mentioned that the amplitude of the oscillation of the edge of the line will depend on amplitude of oscillations of the photomask 11 on the table 2. However, it is more important that this amplitude of oscillations depends also from a level of cutoff of the video signal represented by the line 3′ on FIG. 2. This level is determined by a value of the base signal from regulating source 4 on FIG. 1. By directionally changing a value of the base signal, it is not difficult to set a level of cutoff 3 in the position 4, when the oscillations of the edge of the line on the screen will become minimal. During this process again straight lines shown in FIG. 4 will appear on the screen, and a distance between them will correspond to an actual size of the strip with consideration of a known scale of magnification of the microscope.

The thusly determined size really corresponds to a true size, and this statement is based on the theory of optical images disclosed in above mentioned publication Nikitin, A. V., Nikitin, M. A., Suris R. A. in accordance with which the intensity in representation of the edge does not depend on defocusing. Thereby the points of intersections of sharply focused and defocused images are edges in the representation of the strip.

It will be understood that each of the elements described above, or two or more together, may also find a useful application in other types of constructions differing from the types described above.

While the invention has been illustrated and described as embodied in a device for measuring sizes on photomasks, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A device for measuring sizes on photomasks, comprising a television optical microscope; a system of periodically changing a resolution of the microscope; a regulated source of a base voltage; a comparator of a base signal and a television signal; a former of short pulses; and a display unit.

2. A device as defined in claim 1, wherein said system for periodically changing a resolution of the microscope includes means for periodically partially defocusing an image of an object to be measured.

3. A device as defined in claim 2, wherein said means for periodically partially defocusing an image of an object to be measured includes means for displacing a phototemplate along an optical axis, said displacing means including a generator of disturbing signals, and a mover controlled by said generator and supporting the phototemplate.

4. A device as defined in claim 2, wherein said means for periodically partially defocusing of an image of an object to be measured include means for displacement of an objective of the microscope along an optical axis, said displacing means including a generator of disturbing signals, and a mover controlled by said generator and providing a displacement of the objective.

5. A device as defined in claim 1, wherein said means for periodically changing a resolution of the microscope includes means for periodically changing a digital aperture of an objective of the microscope, and comprising a mechanical drive of an aperture diaphragm and a generator of disturbing signals which controls said mechanical drive.

6. A device as defined in claim 1, wherein said means for periodically changing of a resolution of the microscope include means for periodically changing a digital aperture of an objective of the microscope and comprising a dynamic transparency located in an aperture plane of the objective, and a generator of disturbing signals which controls said transparent.

7. A method of measuring sizes of photomasks, comprising the steps of providing a television optical microscope; periodically changing a resolution of the microscope; regulating a source of a base voltage; comparing a base signal and a television signal; forming short pulses; and displaying on a display unit.

8. A method as defined in claim 7, wherein said periodically changing includes periodically partially defocusing an image of an object to be measured.

9. A method as defined in claim 8, wherein said periodically partially defocusing an image of an object to be measured includes displacing a photomask along an optical axis, by a generator of disturbing signals, and a mover controlled by said generator and supporting the photomask.

10. A method as defined in claim 8, wherein said periodically partially defocusing of an image of an object to be measured includes displacing an objective of the microscope along an optical axis, by a generator of disturbing signals, and a mover controlled by said generator and providing a displacement of the object.

11. A method as defined in claim 7, wherein said periodically changing a resolution of the microscope includes periodically changing a digital aperture of an objective of the microscope, by a mechanical drive of an aperture diaphragm and a generator of disturbing signals which controls said mechanical drive.

12. A method as defined in claim 7, wherein said periodically changing a resolution of the microscope include periodically changing a digital aperture of an objective of the microscope by a dynamic transparency located in an aperture plane of the objective, and a generator of disturbing signals which controls said transparency.
